(19) United States
(12) Patent Application Publication
(10) Pub. No.: US 2017/0243290 A1
(43) Pub. Date: Aug. 24, 2017

(54) MICRO-GRID POWER MANAGEMENT SYSTEM

(71) Applicant: International Business Machines Corporation, Armonk, NY (US)

(72) Inventor: Michael Sean Brown, Wahroonga (AU)

(21) Appl. No.: 15/047,833

(22) Filed: Feb. 19, 2016

(51) Int. Cl. G06Q 40/04; G05F 1/66; G06Q 30/02; G06Q 50/06

(52) U.S. Cl. CPC G06Q 40/04; G06Q 50/06; G05F 1/66; G06Q 30/0202

(57) ABSTRACT

A system for monitoring and assigning available electrical power generation and storage attributes associated with premises in a micro-grid by analyzing supply and demand characteristics of premises in a micro-grid, correlating said characteristics with external sources, coordinating the switching of excess power and storage of excess power for the benefit of members of the micro-grid and, optionally, negotiating the purchase or sale of power to/from a national/state power grid.

### BACKGROUND

The present invention relates to electrical power distribution, and more specifically to methods and systems of controlling electrical power distribution and generation grids.

With the current focus on “green” renewable energy, the advent of personal power generation devices such as roof top solar panels has become commonplace. Currently most buildings which have solar panels are still connected to the main power grid, as such technology generates power during daylight hours, but grid based power is required during the night time. Current schemes exist to sell power back to the grid during peak hours when excess power is available locally.

Other personal power generation systems exist, but are less common than solar. These include, wind, hydro, thermal and fossil fuel based generators.

The next round of technology will include better ways of storing energy locally, which in some cases will allow buildings to go totally “off the grid” and be power self sufficient. One indication of this is the investment Tesla's SolarCity is making in home battery technology.

### SUMMARY

According to one embodiment of the present invention, this is a system, method and computer program product for monitoring and assigning available electrical power generation and storage attributes associated with premises in a micro-grid (eg solar, wind, battery capacity, etc.), analyzing supply and demand (power consumption and generation) characteristics of premises in a micro-grid, correlating said characteristics with external sources such as weather forecasts, seasonal patterns, holiday periods, etc., creating a dynamic pricing structure for power generation and storage, negotiating the sale of excess power and storage of excess power for the benefit of members of the micro-grid and, optionally, negotiating the purchase or sale of power to/from a national/state power grid when such a purchase would be of benefit to the members of the micro-grid.

More specifically, a broker system is provided at a “community” level with analytics applied to that data and a policy regime where a premise can set rules.

The broker service calculates in real time a value for power generation and storage based on supply and demand and effectively gives each premises a credit for the power they have generated or stored on behalf of the micro-grid. For partially “off the grid” systems, the broker service can also decide when to connect to the national or state grid, in order to boost power available, or sell back excess power.

### BRIEF DESCRIPTION OF THE DRAWINGS

FIG. 1 depicts an exemplary diagram of a possible data processing environment in which illustrative embodiments may be implemented.

FIG. 2 depicts a group of premises connected to a micro-grid during a condition of bright sunshine.

FIG. 3 depicts a group of premises connected to a micro-grid during a condition of clouds and high wind.

FIG. 4 depicts a group of premises connected to a micro-grid during a calm night.

FIG. 5 illustrates internal and external components of a client computer and a server computer in which illustrative embodiments may be implemented.

FIG. 6 depicts a flowchart of an embodiment of the method of starting evaluation.

FIG. 7 depicts a flowchart for handling an “excess generation” notification.

FIG. 8 depicts a flowchart for handling an “available storage” notification.

### DETAILED DESCRIPTION

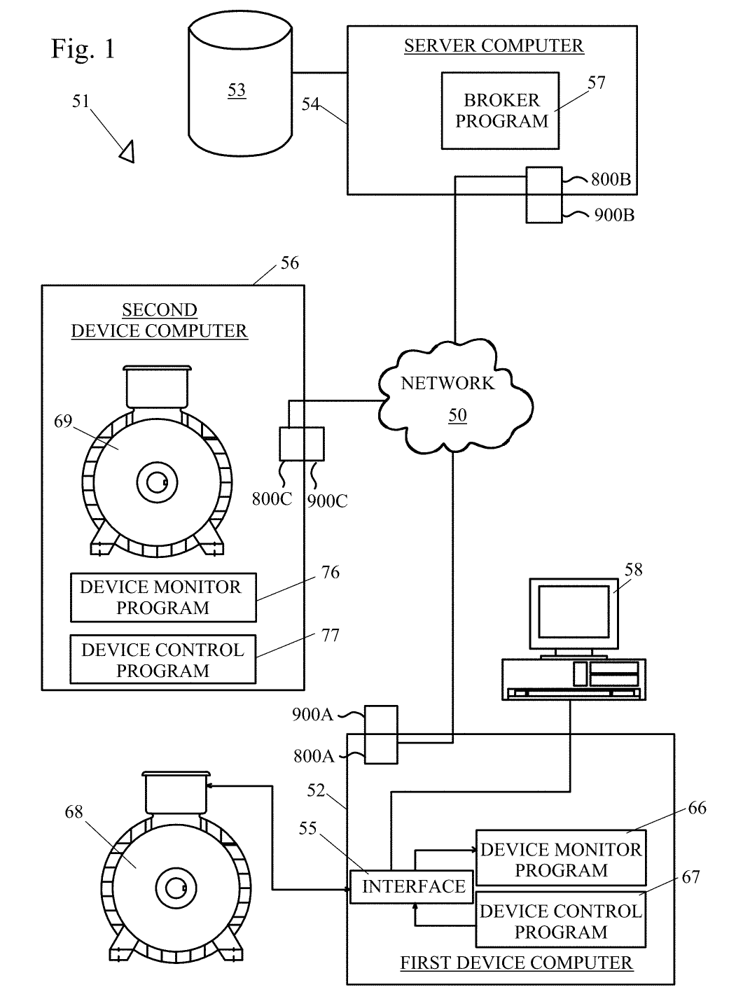

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, a network data processing system such as the Micro-Grid Power Management System 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, server computer 54, first device computer 52 and second device computer 56 are all connected to network 50. In other exemplary embodiments, network data processing system 51 may include additional client computers, storage devices, server computers, and other devices not shown.

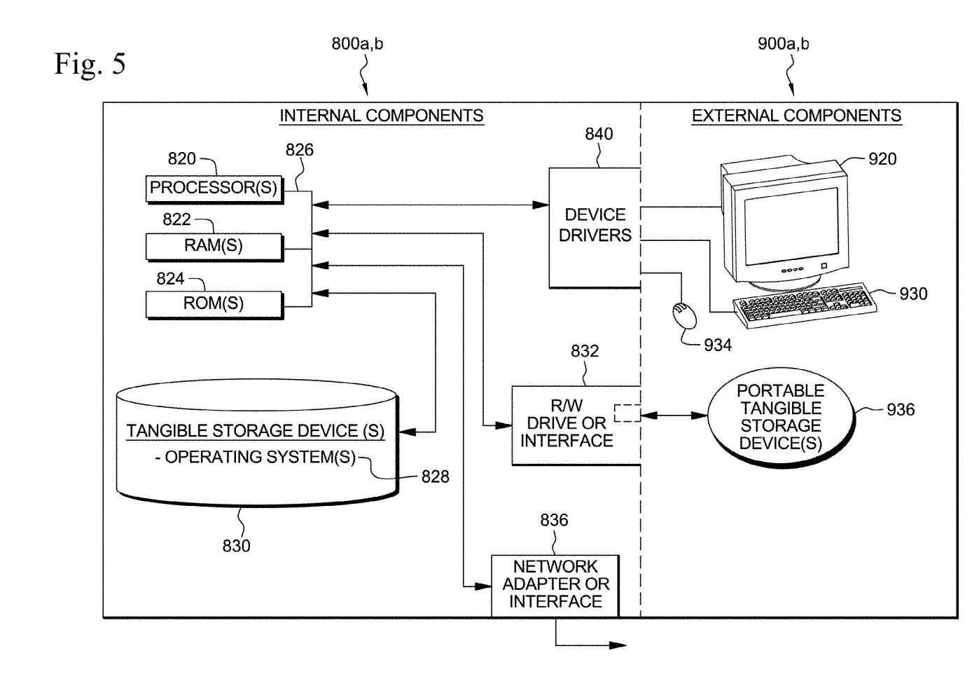

First device computer 52 is a premises control system which includes a set of internal components 800a and a set of external components 900a, further illustrated in FIG. 5. First device computer 52 may be, for example, a netbook, a laptop computer, a desktop computer, or any other type of computing device.

First device computer 52 may contain an interface 55. Through interface 55, first device computer 52 can communicate with a local user through a local display terminal 58, for example, through a command line interface, a graphical user interface (GUI), or a web user interface (WUI). The interface 55 also communicates with on-premises power generation or power storage facilities, such as generator 68. The interface 55 communicates data about the on-premises power generation and storage facilities 68 to programs running on the first device computer 52, for example a device monitor program 66. The interface 55 also communicates control commands to the on-premises power generation and storage facilities 68 from programs running on the first device computer 52, for example a device control program 66. The device monitor program 66 and device control program 67, as well as other programs, can communicate with other computers and the server computer 54 through the network 50.

Second device computer 56 is a processor embedded in a “smart” power or power storage device, such as generator 69, which contains the necessary hardware and software, for example a device monitor program 76 and a device control program 77. Second device computer 56 includes a set of internal components 800a and a set of external components 900a, further illustrated in FIG. 5.

Server computer 54 includes a set of internal components 800b and a set of external components 900b illustrated in FIG. 5. Server computer 54 may contain an interface. The interface can be, for example, a command line interface, a graphical user interface (GUI), or a web user interface (WUI) through which access to a social media monitor program 66. Alternatively, the device monitor program 66 may be on the first device computer 52.

In the depicted example, server computer 54 may provide information, such as boot files, operating system images, and applications to first device computer 52 and second device computer 56. Server computer 54 can compute the information locally or extract the information from other computers on network 50.

Program code and programs such as device monitor program 66 or 76 or device control program 67 or 77 may be stored on at least one of one or more computer-readable tangible storage devices 830 shown in FIG. 5, on at least one of one or more portable computer-readable tangible storage devices 936 as shown in FIG. 5, or on storage unit 53 connected to sever computer 54, or may be downloaded to a computer, such as first device computer 52 or server computer 54, for use. For example, program code and programs such as device monitor program 66 may be stored on at least one of one or more storage devices 830 on server computer 54 and downloaded to first device computer 52 over network 50 for use on first device computer 52. Alternatively, server computer 54 can be a web server, and the program code, and programs such as device monitor program 66 may be stored on at least one of the one or more storage devices 830 on server computer 54 and accessed on first device computer 52. In other exemplary embodiments, the program code, and programs such as device monitor program 66 may be stored on at least one of one or more computer-readable storage devices 830 on first device computer 52 or distributed between two or more servers.

In the depicted example, network data processing system 51 uses the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

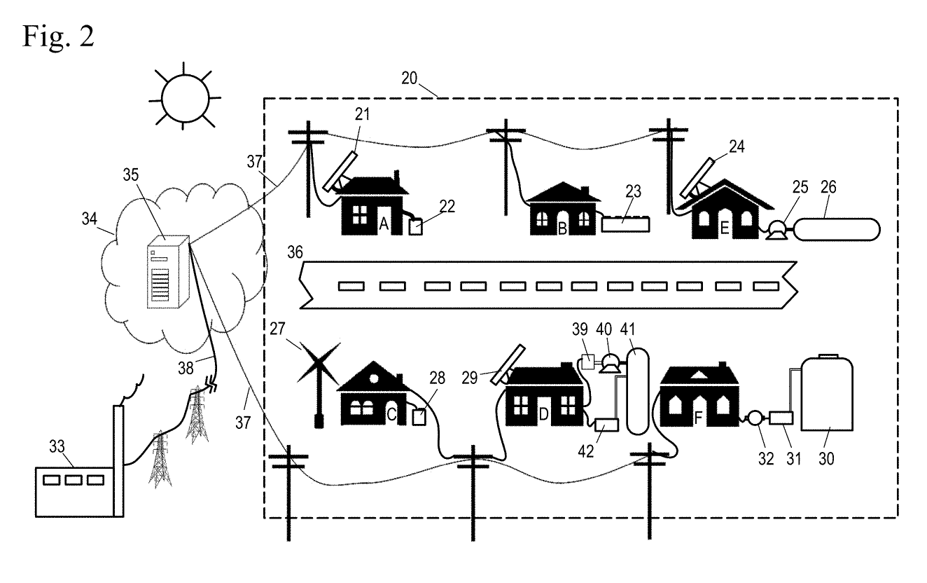

FIGS. 2-4 show an example of a “micro-grid” 20 which may be made up of a defined geographical area such as a street, suburb or estate, or the buildings in an organized facility such as a university or corporate park. Power within, to and from the micro-grid 20 is regulated by the Micro-Grid Power Management System, which may include a server 35 connected to the “cloud” 34 such as the Internet or a private data network. The server 35 implements a cloud-based power broker service, for example through broker program 57 to monitor and control the power flows.

The micro-grid 20 in the example comprises a number of premises, such as buildings A-F, located along a street 36 with the associated wiring 37, generation devices 21, 24, 27, 29 and 30-32 and storage devices 22, 23, 25-26 and 28. The micro-grid 20 in the example is connected to the national or regional power grid, represented in the figure by generating station 33 and high-tension line 38. The premises use electricity for lighting, heating, ventilating and air conditioning (HVAC) systems, powering industrial equipment or household appliances, and so on.

Each of the premises A-F is assigned attributes in the Micro-Grid Power Management System based on its power generation and storage abilities.

When a premises generates an excess amount of electricity, it contacts the broker program 57 running on the server 35 and advertises this fact. The server 35 also keeps track of each premises which has excess storage capacity, as well as tracking historical usage patterns for the micro-grid.

The broker service calculates in real time a value for power generation and storage based on supply and demand, and effectively gives each premises a credit for the power they have generated or stored on behalf of the micro-grid.

For partially “off the grid” systems, the broker service can also decide when to connect to the national or state grid, in order to boost power available, or sell back excess power.

In the example of FIGS. 2-4, all of the premises except B have some form of power generation. While in the example of FIGS. 2-4 all of the premises are represented by buildings A-F, it will be understood that there may be additional free-standing generation devices on the micro-grid 20. The generation devices might be building-mounted or ground-mounted “green” systems such as wind turbine 27 or solar panels 21, 24 and 29 installed on a building roof or on the ground. Some generators might be mechanical electrical generators 32 powered by, for example, internal combustion engine 31, which in a “green” system might be fueled by biodiesel or methane gas from a digester 30 receiving animal or plant waste.

Some of the premises on the micro-grid, such as buildings A-C in the example, may be equipped with electrical power storage devices such as battery packs 22 and 28 or a bank of fuel cells 23.

Other power storage systems might be implemented, such as storage of water in an elevated tank or pond, or, as shown connected to building E, which uses an electrical pump/generator 25 powered by electrical power from the micro-grid 20 or solar cell 24 to compress air in a reservoir 26. When it is desired to recover the stored energy, the pressure from the reservoir 26 powers the pump/generator 25 to generate electricity.

Also possible are systems as shown connected to building D, where power from the micro-grid 20 or an on-premises generator such as solar cell 29 is stored by electrolyzing water in a cell 39 to create hydrogen which is compressed by a compressor 40 and stored under pressure in a tank 41. When it is desired to use power from the system, the hydrogen from the tank 41 is used in a generator such as fuel cell 42 to generate electricity which can be sent back into the micro-grid 20.

Preferably, the generation devices and storage devices are smart devices such as second device computer 56 which can communicate data to and from the server 35 which implements the cloud-based power broker service. Alternatively, a computer in a building or other premises, such as first device computer 52, may be connected to “dumb” devices to collect data and communicate with the server 35. These control and data monitoring systems associated with the premises will be referred to herein as “on-premises control systems”, whether implemented as smart devices or using a computer in the building. The on-premises control systems are communicate with server 35 through the “cloud” 34 using a communication network. The network can be implemented by any means known to the art, such as a local-area (LAN) or wide-area network (WAN), wired or wireless or implemented as a Broadband over Power Line (BPL) system which communicates over the same power lines as connect the generators or storage devices to the micro-grid. The connections can also be made by wireless communication through an area broadband wireless system, or through the cellular network.

In the example shown in FIGS. 2-4, Premises A has a large solar panel installation 21, but very little battery storage 22, so is able to generate a lot of electricity during sunny days, but can store very little for use during the evening or overcast periods.

Premises B has no power generation facility, but a large ability to store power due to a large investment in battery technology 23.

Premises C has very little ability to store power in its battery 28, but has a wind turbine 27, which can generate electricity on windy days and nights

Premises D has the same solar capacity as Premises A, due to its solar panels 29, but has the ability to store huge amounts of energy. Power from the solar panels 29, or from the micro-grid 20, can be turned into hydrogen by breaking water down to hydrogen and oxygen in cell 39. Hydrogen is taken from the cell and compressed by compressor 40 into tank 41. When power is to be used on the premises or fed back to the grid, hydrogen from the tank 41 is fed to a hydrogen fuel cell 42, which generates electricity from the conversion of the hydrogen with oxygen back to water.

Premises E has some power generation facility due to its solar panel 24, which for the sake of this example is smaller than the solar facility in Premises A. On the other hand, Premises E can store more power than Premises A, by using electric power to run compressor 25 to compress air into tank 26. When power is to be used on the premises or fed back to the grid, the compressed air from the tank 26 can run the compressor 25 backwards, turning the motor into a generator.

Premises F, a local dairy farm, has no local storage capacity, but generates its own electricity by processing cow manure in a digester 30 to produce methane gas. The methane fuels an internal combustion engine 31 which powers an electrical generator 32. The cows are always eating and creating manure, so the generating capacity is relatively constant and independent of weather. Since Premises F has relatively constant generating capacity but varying electrical needs—it takes more electricity to run the milking machines and coolers during milking than is needed after the cooled milk is shipped to market—Premises F will sometimes have extra electricity to deliver to the micro-grid 20, and sometimes will need to obtain energy from the micro-grid 20.

The broker program 57 running on server 35 will assign attributes to the premises in the micro-grid 20. The broker program 57 may also assign attributes to external power sources such as the power grid or external power users outside the micro-grid. For the example of FIGS. 2-4, the attributes might be as summarized in the following table:

TABLE 1
Examples of Premises Attributes

| | Attribute 1 | Attribute 2 | Attribute 3 | Attribute 4 | Attribute 5 | Attribute 6 |
|---|---|---|---|---|---|---|
| | Solar | Wind | Diesel | Methane | Battery | Fuel Cell |
| Premises | Generation | Turbine | Generator | Digester | Storage | Storage |
| A | 5 kW | — | — | — | 7 kWh | — |
| B | — | — | — | — | 20 kWh | — |
| C | — | 2 kW | — | — | 10 kWh | — |
| D | 10 kW | — | — | — | — | 25 kWh |
| E | — | — | — | 8 kW | — | — |
| Power | * | * | * | * | * | * |
| Grid | | | | | | |

Using the example of FIG. 2, let us suppose that it is late afternoon on a warm summer day, and the street is enjoying calm, sunny weather.

In this example, Premises A may be generating excess power over the requirements of the occupants and facilities on the premises. Premises A will quickly fill the small amount of on-site energy storage in its battery 22. Rather than waste the excess power, the on-premises control system at Premises A contacts the server 35 and indicates it has excess power.

Premises B has no generating capacity of its own, but notifies the Server 35 that it has spare storage capacity in its large battery farm 23. In this case Premises B may store power on behalf of Premises A. Alternatively, rather than storing on behalf of Premises A, Premises B may offer to buy excess power at the going rate, and sell it back when the rate is higher. Premise B will inform the broker program of the status of all its devices (in this case just battery storage and capacity). This is done on a continual basis. The choice to “store on behalf” vs “buy and sell-back” is made by a policy configuration set up on the broker server at the agreement of the owners of the connected premises.

Premises C is not generating any power because there is no wind to drive its turbine 27. Its small battery 28 was fully charged the last time there was any wind, so Premises C cannot store any more power. As the day is warm, Premises C may have a higher than normal requirement for power from the micro-grid to run the air conditioning for the offices on the premises. Premises C notifies the server 35 of its power requirement and its generation and storage status.

Premises D, like Premises A, is generating more solar power from its large solar array 29, but it can store the excess power on-site by generating hydrogen in the cell 39 and using compressor 40 to store the hydrogen in tank 41. Premises D notifies server 35 that it has excess storage capacity over the amount which it is currently using to store its own solar energy.

Premises E is using all of the solar energy it can produce in its solar panel 24, and is also using some compressed air from tank 26 to provide additional energy for the high air-conditioning load. Premises E notifies the server 35 that it cannot store any power, and it does not need power from the micro-grid.

Premises F has just milked the cows, and needs excess power over what it can generate on-site from its methane generator 32. Premises F notifies the server 35 that it needs to obtain power from the micro-grid.

In this scenario during hot sunny days, the buildings with solar installations may choose to charge their own battery installations first, and then contact the broker service to see who is offering power storage at the lowest rate. In this case Premises B may store power on behalf of Premises A. Alternatively, rather than storing on behalf, Premises B may offer to buy excess power at the going rate, and sell it back when the rate is higher.

Broker configurations may vary depending on the conditions of sign-up. For example a policy may be set so that energy may not be stored on the owners behalf, but only sold at the going rate. There may be a requirement to sell at a given rate so that all houses are guaranteed of a continuous power supply. For partially off-the-grid systems, the broker could choose to only used power from the national grid if the rate rises above commercial price. All energy could be trued up at the end of the month, and premises (such as those with no power equipment) could be invoiced in real currency.

In essence, then, the server will receive notifications (or poll the devices) and this will generate events such as excess power generates or available storage events. It then compares these to the historical database and known generation/storage attributes, and historical usage/generation patterns, and tries to predict how long this excess generation or storage will last for. It then does a best match between devices across the different premises.

If no ideal match is found it has the option of selling power back to the national grid, or buying power to make best use of the pooled storage devices. Once this is done, the physical power switching is initiated and the ledger is updated.

The broker program 57 on the server 35 accumulates the data from the notifications sent by Premises A-F and, optionally, stores the data in repository 53.

Using attributes for the premises previously assigned by the broker program 57, the server assigns a cost to the power generated by each of the premises. This is calculated in real time using a supply & demand model, and other factors like the retail price from the national grid. Things like max/min pricing and other rules etc can be set in the micro-grid policy using a software interface.

A cost of power purchased from the power grid will also be assigned, based on real-time quotes from power suppliers. This can be varied real time and changed as pricing structures change, which can be set by policy.

Using attributes for the premises previously assigned by the broker program 57, the server also assigns a cost to the power storage capacity at each of the premises This will be a supply & demand model. The outcome we are driving is that if many people have generation devices (eg solar) and few have storage, the premises with storage devices are better off. ie they would pay less for excess power to use or resell. This will encourage other premises to invest in storage capacity. Prices can be referenced to the national grid, or in the case of isolated/non-connected micro-grids the broker can work out a price at the agreement of the owners as per the policy. The cost will be the same for all premises, but will rise and fall based on demand.

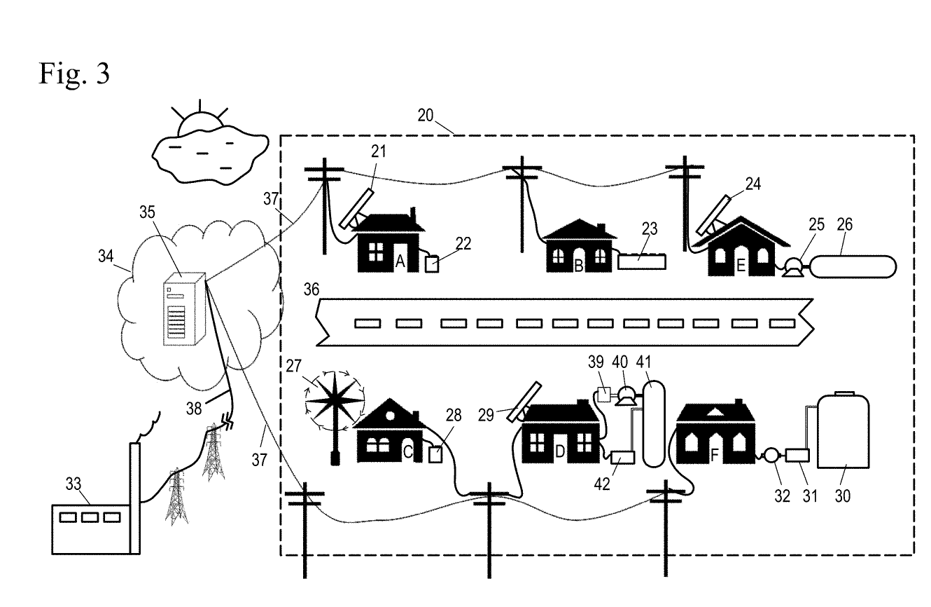

In example of FIG. 3, a cold front has moved in after the sunny afternoon of FIG. 2, the sun has become obscured by heavy cloud, and the wind has picked up.

In this example, the solar panel 21 on Premises A is generating only a little power, insufficient to meet the requirements of the occupants and facilities on the premises. Premises A will quickly exhaust the small amount of on-site energy storage in its battery 22. The on-premises control system at Premises A contacts the server 35 and indicates it has a need to purchase power.

Premises B notifies the server 35 of how much power it had stored during the sunny period, and that it has both power to sell and spare storage capacity in its large battery farm 23. Premises B will only notify the server when it has an “excess storage event”—i.e. any of its own storage devices are full. The server uses historical data, external data (weather, etc.) and known attributes of premises B to predict how long this excess power generation event may last.

Premises C is now generating a lot of power because there is ample wind to drive its turbine 27. Its small battery 28 was quickly fully charged by the first power generated from the quickening wind, so Premises C cannot store any more power. As the day has cooled off, the air conditioning load is reduced, and the need to power office equipment is gone because the work day is over, so Premises C notifies the server 35 that it has excess power to sell. The broker software will do the analysis and prediction.

Premises D, like Premises A, is generating little solar power from its large solar array 29, but, like Premises B, it has stored excess power on-site from the sunny day in the form of hydrogen in tank 41. The on-site controller has been using some of the hydrogen in fuel cell 42 to serve its own needs, but there is capacity to spare. Premises D notifies server 35 that it has both power to sell and excess storage capacity over the amount which it is currently consuming on-site.

Premises E can no longer depend on solar energy from solar panel 24, so it is using compressed air from tank 26 to provide additional energy for on-site needs. This is insufficient to provide all of the power needed, so premises E notifies the server 35 that it needs to buy power.

Afternoon milking is over, and the milk has been cooled and stored, reducing the power load at Premises F. This means that Premises F can now generate more power on-site from its methane generator 32 than it needs to use. Premises F notifies the server 35 of its excess power capacity—it just indicates the “spare storage capacity” event to the server, and the server does the remaining analysis and decision making.

The broker program 57 on the server 35 accumulates the data from the notifications sent by Premises A-F and, optionally, stores the data in repository 53.

Using attributes for the premises previously assigned by the broker program 57, the server assigns a cost to the power generated by each of the premises. This is done by the server based on the policy set by the owners. The price will vary based on supply and demand, but will be the same across all premises at any given time.

A cost of power purchased from the power grid will also be assigned, based on real-time quotes from power suppliers. The cost could be a single value, or a constantly varying blend cost based on a mix of different suppliers for different amounts of power. Or, the broker program could get quotes for power separately from different suppliers based on instantaneous bids for the particular demand needed right then. The owners can agree to reference their pricing to the national power grid, or not. This is set in the policy, and is more relevant for micro-grids which are connected to the national grid.

Using attributes for the premises previously assigned by the broker program 57, the server also assigns a cost to the power storage capacity at each of the premises. This is done based on supply and demand, but would be the same across all storage devices across the premises.

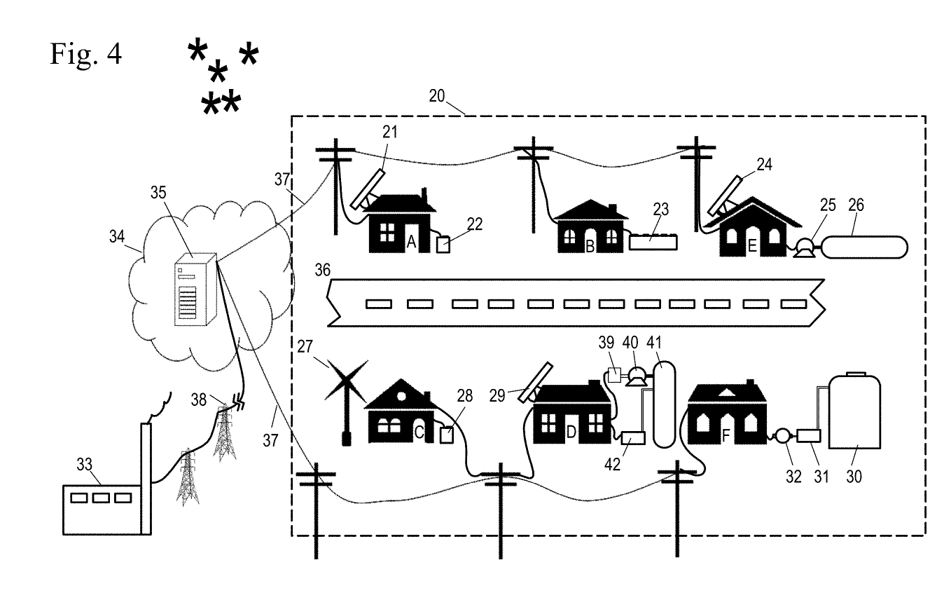

In example of FIG. 4, night has fallen and the wind has died down on a cold, clear night.

In this example, the solar panel 21 on Premises A is generating no power, and lights and heat have come on, creating additional power demand. Premises A has exhausted the small amount of on-site energy storage in its battery 22. The on-premises control system at Premises A contacts the server 35 and indicate it has a need to purchase power.

Premises B notifies the Server 35 of how much power it has left from what it had stored during the sunny period, and that it has both power to sell and spare storage capacity in its large battery farm 23. A single premises would never have both excess power and excess storage. They fill their own storage first. The only events are excess power generation and spare storage capacity.

With the wind calm, Premises C is no longer generating any power from its turbine 27. With the offices dark and the heating load low on night setback, Premises C can satisfy its power needs from on-site storage 28 which was charged by the turbine 27. Premises C notifies the server 35 that it has neither power to sell nor a need to buy power. Telemetry data from the generation, storage and consumption meters on each premises is constantly being collected. This is stored in a database and used for analytics combined with external data such as weather etc. However, the only event triggers are “excess storage events” and “spare storage capacity events” which trigger the analysis to happen as per the flowcharts.

Premises D, like Premises A, is generating no solar power from its large solar array 29, but, like Premises B, it still has stored excess power on-site from the sunny day in the form of hydrogen in tank 41. The on-site controller has been using some of the hydrogen in fuel cell 42 to serve its own needs, but there is capacity to spare. Premises D notifies server 35 that it has both power to sell and excess storage capacity over the amount which it is currently consuming on-site.

Premises E can no longer obtain any solar energy from solar panel 24, and it has used all of the compressed air from tank 26 during the cloudy evening. Premises E notifies the server 35 that it needs to buy power.

Premises F is still generating more power on-site from its methane generator 32 than it needs to use. Premises F notifies the server 35 of its excess power capacity by sending an “excess power generation” event.

The broker program 57 on the server 35 accumulates the data from the notifications sent by Premises A-F and, optionally, stores the data in repository 53.

Using attributes for the premises previously assigned by the broker program 57, the server assigns a cost to the power generated by each of the premises.

A cost of power purchased from the power grid will also be assigned, based on real-time quotes from power suppliers.

Using attributes for the premises previously assigned by the broker program 57, the server also assigns a cost to the power storage capacity at each of the premises.

Based on the stored data in the repository 53 and the costs assigned for generation and storage for each of the premises, the broker program 57 now proceeds to manage the power on the micro-grid.

Under the right conditions during the night or overcast weather, the broker service may calculate a higher rate for energy as the buildings with solar installations may not be generating any electricity. In this case Premises C may be able to sell wind generated power at a premium rate, and Premises B may also choose to sell back power at this rate.

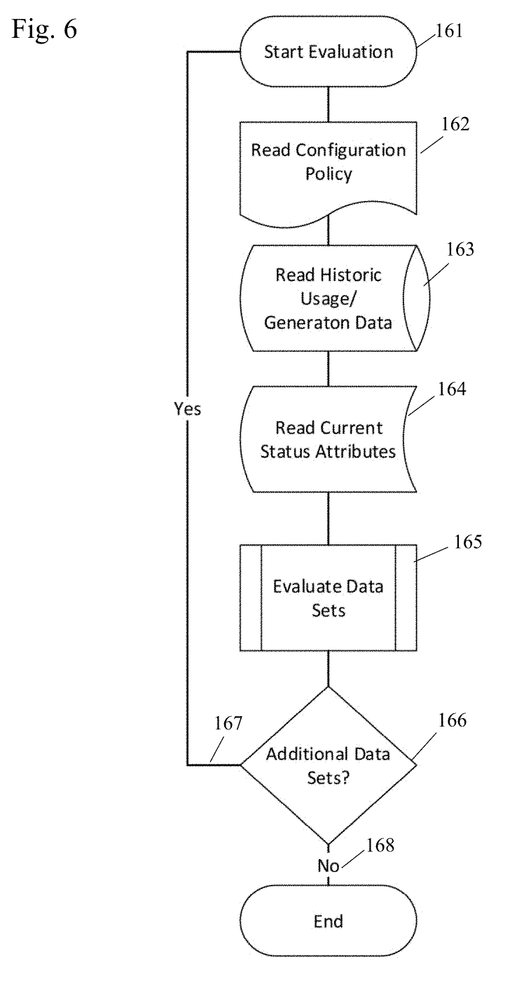

The method of operation of the broker program is shown in the flowchart of FIGS. 6-8, as follows:

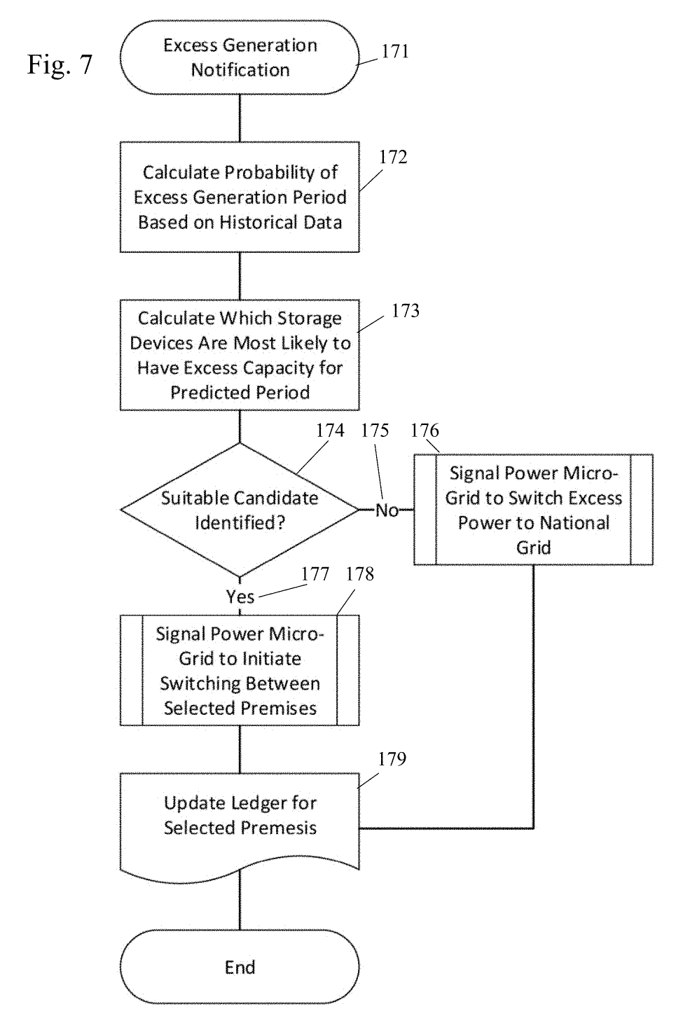

FIG. 7 shows a flowchart of how the broker program 57 running on the server 35 proceeds when it receives a notice of excess generation from a premises on the micro-grid.

Step 171: A notification of excess generation is received from a premises.

Step 172: The broker program 57 calculates the probable length of the excess generation period from the historical data, to predict the period during which the premises will have excess generation capacity.

Step 173: The broker program 57 calculates which premises would be most likely to have storage devices with excess capacity during the predicted period.

Step 174: If there is a suitable candidate premises which was calculated to have available storage sufficient to store the excess generation during the predicted period 177, then (Step 178) the micro-grid is signaled to initiate switching the excess power from the premises which sent the notice of excess generation to the suitable candidate premises. If there was no suitable candidate premises identified 175, then (Step 176) the micro-grid is signaled to initiate switching the excess power from the premises which sent the notice of excess generation to the national grid.

Step 179: The ledger is updated to indicate the sending of power from the premises which sent the notice of excess generation, and the method ends. This updating can be done by assigning credits for premises providing the services or using real monetary (dollar) values which vary depending on demand (this choice is set by the owners in the policy).

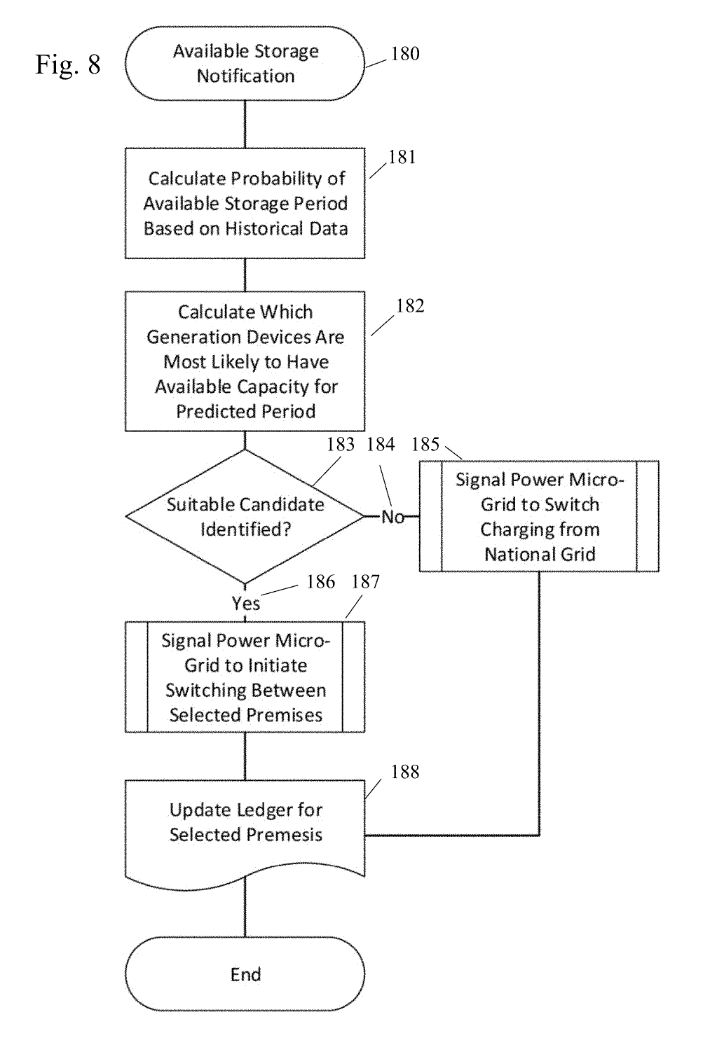

FIG. 8 shows a flowchart of how the broker program 57 running on the server 35 proceeds when it receives a notice of available storage from a premises on the micro-grid.

Step 180: A notification of available storage is received from a premises.

Step 181: The broker program 57 calculates the probable length of the available storage period from the historical data, to predict the period during which the premises will have available storage capacity.

Step 182: The broker program 57 calculates which premises would be most likely to have available excess generation capacity during the predicted period.

Step 183: If there is a suitable candidate premises which was calculated to have available excess generation capacity sufficient to provide power to store in the available storage during the predicted period 186, then (Step 187) the micro-grid is signaled to initiate switching the excess power from the suitable candidate premises to the premises which sent the notice of available storage. If there was no suitable candidate premises identified 184, then (Step 185) the micro-grid is signaled to initiate switching power from the national grid to the premises which sent the notice of available storage.

Step 188: The ledger is updated to indicate the storage of power to the premises which sent the notice of available storage, and the method ends. This updating can be done by assigning credits for premises providing the services or using real dollar values which vary depending on demand (this choice is set by the owners in the policy).

FIG. 6 shows a flowchart of the method of the evaluation process by the broker program 57 on the server 35, which is used in steps 172, 173, 181 and 182 of the method of FIGS. 7 and 8 discussed above.

Step 161: The method is started.

Step 162: Configuration policy is read from a repository.

Step 163: Historic usage and generation data is read from a repository.

Step 164: The current status attributes are read from each of the premises on the micro-grid.

Step 165: The data sets are evaluated. Weather forecasts, public holidays etc, may be a factor in determining how long a excess power event or available storage events will last.

Step 166: If there are more data sets to evaluate, the method repeats 167 from step 161. If there are no further data sets to evaluate 168, the method ends.

Broker configurations may vary depending on the conditions of sign-up. For example a policy may be set so that energy may not be stored on the owners' behalf, but only sold at the going rate. There may be a requirement to sell at a given rate so that all houses are guaranteed of a continuous power supply. For partially off-the-grid systems, the broker could choose to only use power from the national grid if the rate rises above commercial price. Policy would be set via a software interface (e.g. a web interface) by authorized users and agreed by the premises owners.

In addition to the control of power generation and storage on the premises, and controlling purchases of power from the national grid and sale of power to the national grid, the broker program 57 on the server 35 can also keep track of monetary balances earned or owed by the premises A-F in the micro-grid 20. All balances could be reconciled at the end of a billing period, for example at the end of each month. Premises with a positive balance could be paid for the excess power they had sold or stored during the period, while those with a negative balance (such as those with no power equipment) could be invoiced in real currency.

FIG. 5 illustrates internal and external components of the first device computer 52 and server computer 54 in which illustrative embodiments may be implemented. In FIG. 4, the first device computer 52 and the server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, device monitor program 66 are stored on at least one of one or more of the computer-readable tangible storage devices 830 for execution by at least one of one or more of the processors 820 via at least one of one or more of the RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Device monitor program 66 can be stored on at least one of one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Device monitor program 66 can be downloaded to First device computer 52 and server computer 54 from an external computer via a network (for example, the Internet, a local area network or other, wide area network) and network adapter or interface 836. From the network adapter or interface 836, device monitor program 66 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Device monitor program 66 can be written in various programming languages including low-level, high-level, object-oriented or non object-oriented languages. Alternatively, the functions of device monitor program 66 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of managing power generation and storage in a plurality of premises connected to a micro-grid comprising the steps of:
receiving a notification regarding a condition of available power generation or power storage from one of the plurality of premises connected to the micro-grid;
reading configuration policy from a repository;
reading historic usage and generation data from a repository;
reading current status attributes of each of the plurality of premises connected to the micro-grid;
evaluating the historic usage and generation data to calculate a probable length of the condition of available power generation or storage;
evaluating the current status attributes of the plurality of premises to determine premises with available power storage or power generation to match with the premises from which the notification was received; and
if there is at least one premises with available power storage or generation, switching power between the premises from which the notification was received and premises connected to the micro-grid with excess power generation or available power storage.

2. The method of claim 1, in which the notification comprises a notification of excess generation capacity at the premises.

3. The method of claim 1, in which the notification comprises a notification of available storage capacity at the premises.

4. The method of claim 1, further comprising the step of updating a ledger with information regarding the switching power between the premises from which the notification was received and premises connected to the micro-grid with excess power generation or available power storage.

5. The method of claim 4, in which the updating of information on the ledger comprises assigning credits.

6. The method of claim 4, in which the updating of information on the ledger comprises assigning monetary values based on real-time quotes from power suppliers.

7. The method of claim 4, in which the updating of information on the ledger comprises assigning monetary values based on a cost associated with each of the premises.

8. The method of claim 1, further comprising the step of, if there is no premises with available power storage or generation, switching power between the premises from which the notification was received and a national power grid.

9. The method of claim 1, in which the historic usage and generation data comprise at least one of weather forecasts and data regarding public holidays.

10. A computer system for managing power generation and storage in a micro-grid comprising a computer comprising at least one processor, one or more memories, one or more computer readable storage media having program instructions executable by the computer to perform the program instructions comprising:
receiving, by the computer, a notification regarding a condition of available power generation or power storage from one of the plurality of premises connected to the micro-grid;
reading, by the computer, configuration policy from a repository;
reading, by the computer, historic usage and generation data from a repository;
reading, by the computer, current status attributes of each of the plurality of premises connected to the micro-grid;
evaluating, by the computer, the historic usage and generation data to calculate a probable length of the condition of available power generation or storage;
evaluating, by the computer, the current status attributes of the plurality of premises to determine premises with available power storage or power generation to match with the premises from which the notification was received; and
if there is at least one premises with available power storage or generation, switching power, by the computer, between the premises from which the notification was received and premises connected to the micro-grid with excess power generation or available power storage.

11. The computer system of claim 10, in which the notification comprises a notification of excess generation capacity at the premises.

12. The computer system of claim 10, in which the notification comprises a notification of available storage capacity at the premises.

13. The computer system of claim 10, further comprising the program instructions of updating, by the computer, a ledger with information regarding the switching of power between the premises from which the notification was received and premises connected to the micro-grid with excess power generation or available power storage.

14. The computer system of claim 13, in which the updating of information on the ledger comprises assigning credits.

15. The computer system of claim 13, in which the updating of information on the ledger comprises assigning monetary values based on real-time quotes from power suppliers.

16. The computer system of claim 13, in which the updating of information on the ledger comprises assigning monetary values based on a cost associated with each of the premises.

17. The computer system of claim 10, further comprising the program instructions of, if there is no premises with available power storage or generation, switching power, by the computer, between the premises from which the notification was received and a national power grid.

18. The computer system of claim 10, in which the historic usage and generation data comprise at least one of weather forecasts and data regarding public holidays.

19. A computer program product for managing power generation and storage in a micro-grid comprising a computer comprising at least one processor, one or more memories, one or more computer readable storage media, the computer program product comprising a computer readable storage medium having program instructions embodied therewith, the program instructions executable by the computer to perform a method comprising:
receiving, by the computer, a notification regarding a condition of available power generation or power storage from one of the plurality of premises connected to the micro-grid;
reading, by the computer, configuration policy from a repository;
reading, by the computer, historic usage and generation data from a repository;
reading, by the computer, current status attributes of each of the plurality of premises connected to the micro-grid;
evaluating, by the computer, the historic usage and generation data to calculate a probable length of the condition of available power generation or storage;
evaluating, by the computer, the current status attributes of the plurality of premises to determine premises with available power storage or power generation to match with the premises from which the notification was received; and
if there is at least one premises with available power storage or generation, switching power, by the computer, between the premises from which the notification was received and premises connected to the micro-grid with excess power generation or available power storage.

20. The computer program product of claim 19, further comprising the program instructions of updating, by the computer, a ledger with information regarding the switching of power between the premises from which the notification was received and premises connected to the micro-grid with excess power generation or available power storage.
